(19) United States
(12) Patent Application Publication
(10) Pub. No.: US 2013/0161880 A1
(43) Pub. Date: Jun. 27, 2013

(54) METHOD FOR CREATING CERAMIC PHOTOS

(71) Applicant: Lawrence G. Kurland, Jericho, NY (US)

(72) Inventor: Lawrence G. Kurland, Jericho, NY (US)

(21) Appl. No.: 13/337,966

(22) Filed: Dec. 27, 2011

(51) Int. Cl. C04B 35/622

(52) U.S. Cl. 264/642

(57) ABSTRACT

A method for providing a three dimensional photographic scenic image, such as a portrait or other scene, on a ceramic substrate from an actual colored photographic image of the scene. The photographic image is transferred to the ceramic substrate, such as by a heat transfer process, after which it can be hand colored, or automatically by use of an ink jet printer, with the image being colorized using ceramic paints, such as water based or acrylic ceramic paints, in colors corresponding to the actual color photographic image, and the ceramic painted color image is then fired, such as in a home type oven, to create the finished decorative product. The fired workpiece may then be sealed, or, alternatively, it may be glazed in a kiln, if desired. A frame may also be provided around the ceramic photographic image containing ceramic substrate.

### FIELD OF THE INVENTION

The present invention relates to the art of creating ceramic images of photographs for producing decorative objects, and particularly to colorized three dimensional ceramic reproductions of actual color photographs on ceramic substrates, such as ceramic tiles, trays or other ceramic or porcelain objects.

### BACKGROUND OF THE INVENTION

The art of ceramics, and the painting of ceramic tiles with ceramic paints which are then fired and often glazed to produce decorative tiles and other decorative porcelain objects is a well known and ancient art. This art has long depended on the use of expensive and cumbersome equipment such as kilns to fix the ceramic artwork, as well as on the artistic skill of the artist. Over time, this art has also developed into a hobby for those less skilled and who find themselves in the need of aids to assist in producing the types of creative ceramic artwork skilled artisans can create based on their skill alone. Accordingly, over the years, techniques aided by stencils and other known image transfer techniques have been developed as this art has developed as a hobby among those less skilled in the actual creation of the decorative design itself. A typical prior art approach to aid such hobbyists is based on applying a multilayer stencil in order to create a decorative pattern on a surface, such as metal, wood, glass or ceramic, such as described in U.S. Pat. No. 8,061.269. In addition, although ink jet printers have been used to apply designs to various materials, including fine art and photographs to paper and canvas, such as described in U.S. Pat. No. 7,980,649, as well as to provide imprints or markings on ceramic materials, such as described in U.S. Pat. Nos. 7,695,556 and 5,204,055, they have not been employed to create three dimensional ceramic reproductions of actual photographs of scenes or portraits.

Another aid which has developed over the years to help the hobbyist, as well as the skilled artisan, was the introduction of water based or acrylic ceramic paints which could be dried and set in a conventional home oven at temperatures in the range of 300 degrees Fahrenheit rather than using expensive, high temperature kilns requiring temperatures in excess of 1000 degrees. The introduction of such ceramic paints, such as commercially available from Pebeo, such as its Porcelaine 150 series, or from Marabu, have further aided in bringing the art of ceramic painting into the home from the workshop. In addition, other prior art techniques of colorizing ceramics, such as by using aqueous solutions of chromophore ions, such as described in U.S. Pat. No. 7,811,508, have also been developed to move away from the more traditional solid ceramic pigments in order to more readily obtain additional aesthetic effects. The development of these newer types of ceramic paints which may be easier to use still, however, do not substitute for the skill of the artist in creating the artwork itself. This is particularly evident when the ceramic artwork to be created is to be a ceramic reproduction of an actual photograph of a scene, such as a portrait, requiring high levels of skill, Although image transfer techniques for transferring two-dimensional photographic images to ceramic objects, such as by printing them on mugs or plates, such as commercially available in your local drugstore as Holiday gifts, are well known, no techniques has been developed or employed for readily creating three-dimensional colored ceramic images of actual colored photographs, such as is accomplished by the method of the present invention

Thus, it is believed that there is a need for the method of the present invention in creating decorative ceramic objects containing three-dimensional colored ceramic images of actual colored photographs.

### SUMMARY OF PARTICULAR EMBODIMENTS OF THE INVENTION

The present invention provides a method for creating decorative ceramic objects containing three-dimensional ceramic images of actual photographs which have been fired on the ceramic substrate, such as in a home type oven, such as such ceramic photographic reproductions contained on a ceramic or porcelain tile or a ceramic or porcelain tray with or without a surrounding decorative frame. In accordance with the method of the present invention, a colored photographic image is transferred to the ceramic substrate, such as via an image transfer process, the transferred photographic image is then colorized in accordance with the colored photographic image by utilizing ceramic paints, such as water based or acrylic paints; the painted image is then fired to set and dry the ceramic reproduction of the colored photograph on the ceramic substrate, such as in a home type oven at approximately 300 degrees for 30 minutes, and the decorated ceramic object containing the ceramic reproduction of the actual colored photograph is then removed from the oven. If desired, a sealer can then be applied to the fired artwork or, where appropriate, it can be glazed in a kiln, such as by using a clear or transparent glaze.

If a frame is desired around the decorated object as part of the finished artwork, then a porcelain frame can be used as part of the substrate base and then hand painted with porcelain paint in any desired pattern prior to firing of the complete decorative object. Alternatively, the frame could be separately produced and attached to the finished decorative ceramic object.

In accordance with the method of the present invention, the colored photographic image alone could be transferred to the ceramic base, through any of several image transfer techniques, or projected onto the ceramic base, and the resultant transferred image hand painted with ceramic paints, or the actual color photographic image could be sprayed on to the ceramic substrate with ceramic paints from an ink jet printer adapted to spray such ceramic paints under control of a computer or microprocessor in a manner similar to the type of techniques used to print or paint fine art from digitized photographs. In any event, the colored ceramic painted image contained on the ceramic substrate is then fired to create the finished product as discussed above, which may then be sealed or, if desired, subsequently glazed in a kiln.

Various benefits and features of the present invention may become apparent from the following detailed description considered in conjunction with the accompanying drawings. It is to be understood, however, that the drawings are designed solely for purposes of illustration and not as a definition of the limits of the invention for which reference should be made to the appended claims.

### BRIEF DESCRIPTION OF THE DRAWING

Further features of the invention, its nature and various advantages will be more apparent from the following detailed description of the embodiments, taken in conjunction with the accompanying drawing in which:

FIG. 1 is a diagrammatic illustration of typical steps employed in performing the method of the present invention.

### DETAILED DESCRIPTION OF EMBODIMENTS OF THE INVENTION

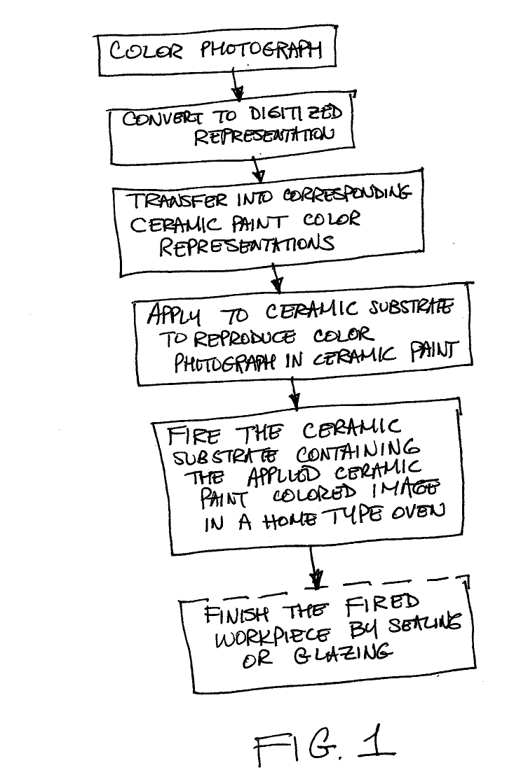

Referring now to FIG. 1, this is a diagrammatic illustration of typical steps employed in performing the method of the present invention for creating a three-dimensional color photographic scenic image, such as a portrait or other scene, on a conventional ceramic substrate in order to make a decorative ceramic colored photo object, such as a ceramic serving tray whose base contains the three-dimensional colored ceramic photo image, or a ceramic tile or other substantially planar ceramic object. Of course, if desired, other non-planar shapes can be employed without departing from the spirit and scope of the invention. In using the term “three-dimensional photographic image”, it is intended to refer to the translation of a conventional two-dimensional photograph present in a single plane into a ceramic image thereof which inherently has some associated depth or thickness and is, therefore, considered to be “three-dimensional” as that term is used herein.

Before describing the method of the present invention, suffice it to say that well known variations on ink jet printers to enable such devices to spray paint or other liquids as opposed to ink exist , such as the use of such conventional ink jet printers to place marks on honeycomb ceramic structures, as described in U.S. Pat. No. 7,695,556, the use of sprayed aqueous solutions to color ceramics, such as described in U.S. Pat. No. 7,811,508; and the use of color ink jet printers to print fine art on different mediums, such as described in U.S. Pat. No. 7,980,649. In such instances, it is well known that the ink jet printer, in conjunction with a conventional microprocessor control, digitizes the image to be printed and then, under control of the microprocessor, prints the final image from the digitized image.

The method of the present invention takes advantage of this capability of ink jet printers of this type and, instead of using ink or some other medium, utilizes conventional water based or acrylic colored ceramic paint of the type conventionally used to make ceramics, such as commercially available from Pebeo, such as, for example, its series of ceramic paints distributed under the designation Porcelaine 150, or such as commercially available from Marabu. As will be described in greater detail hereinafter, not only are these ceramic paints water based and thus of a sufficient viscosity to be sprayed by commercially available ink jet printers, but they may be readily dried and set in a conventional home oven, rather than a kiln, such as at temperatures in the normal range of 300 degrees Fahrenheit for a period of approximately 30 minutes. Of course, one advantage of utilizing the ink jet printer is that it can conventionally utilize a color mixing process to provide the corresponding hues and colors to the ceramic image most closely matching the colored photographic image being produced, similar to the manner in which inks are mixed to produce color photographic reproductions from a digitized image of the actual color photograph. Although the use of the ink jet printer to apply the ceramic paint overcomes any issues which are dependent on the artistic skill of the user creating the ceramic photographic reproduction on the ceramic substrate, as will also be explained in greater detail hereinafter, if desired, the ceramic paint may, instead, be applied by hand, such as through use of an image template of the colored photographic scenic image which has previously been transferred to the ceramic substrate, such as by a conventional heat transfer process, such as described in U.S. Pat. No. 8,061,269, and which is then hand painted using the transferred photographic image template as a guide. In any event, once the colored photographic scenic image, such as a portrait or any other scene, has been placed on the ceramic substrate and colored with the corresponding ceramic paint, it is ready to be conventionally fired, such as in the home type oven, to complete the process.

The firing step for ceramic paints which are water based is a well known conventional process involving the use of a home type oven rather than a kiln since these paints set at a considerably lower temperature than the solid type pigments many artists use in making ceramic artwork, which are temperatures in excess of 1000 degrees Fahrenheit and are capable of forming the ceramics substrate itself. Thus, as noted above, the water based ceramic and acrylic paints discussed above have been found to set and dry in a home type conventional oven set at a temperature in the range of 300 degrees Fahrenheit over a period of approximately 30 minutes. Preferably, the painted ceramic substrate is placed in a cold oven set at 300 degrees Fahrenheit and, when this set temperature is reached in the oven, the painted ceramic substrate is then allowed to bake for 30 minutes and then cooled down in the closed oven. If further finishing of the fired or baked ceramic substrate containing the ceramic painted color photograph reproduction, then the fired artwork may be sealed by using a conventional sealer of the type used with such paints or, if desired, and the material is capable of withstanding the heat without deforming, it may be glazed by applying a conventional glaze and then reheating it in a kiln at the temperature required to set the glaze applied.

Summarizing the above method, one starts with a colored photograph of a scene, such as a portrait or any other scene. You then conventionally digitize the photograph, such as by scanning it, and utilize an ink jet printer, or you create either a heat transferrable template or other image template which can be applied directly to the conventional ceramic substrate to be decorated, such as, for example, the base of a serving tray. The digitized image is then converted into a corresponding ceramic paint color representation of the digitized colored photographic image and applied to the ceramic substrate to reproduce the colored photographic scenic image on the ceramic substrate. The application of the ceramic paint, which is preferably water based or acrylic ceramic paint, is either done automatically by the ink jet printer under control of the microprocessor, in which instance no image template is needed, or done by hand onto the previously applied image template. In either event, the ceramic substrate now containing the ceramic paint colored image is then placed in a conventional home type oven and fired to finish the product. Which may, thereafter, be sealed or glazed if desired

If desired, the ceramic substrate workpiece may contain a ceramic frame which surrounds the base on which the ceramic photo is created or a separate frame of any desired material may be conventionally attached to the finished ceramic substrate. If the ceramic substrate contains a ceramic frame, it may be separately decorated as desired to create the finished decorative product. For example, the ceramic substrate may become an insert for a wooden or metal tray.

While there have shown and described various novel features of the invention, it will be understood that various omissions and substitutions and changes in the form and details of the method described and illustrated may be made by those skilled in the art without departing from the spirit and scope of the invention which is defined by the scope of the claims appended hereto.

What is claimed is:

1. A method for providing a three-dimensional photographic scenic image on a ceramic substrate comprising the steps of: converting an actual colored photographic image of a scene into a digitized representation thereof; transferring said digitized representation of said colored photographic image into corresponding ceramic paint color representations of said digitized colored photographic image; applying said ceramic paint color representations to said ceramic substrate for reproducing said colored photographic scenic image on said ceramic substrate in said ceramic paint; and
firing said ceramic substrate containing said applied ceramic paint colored image at a predetermined temperature and duration sufficient to dry and set said ceramic paint colored image on said ceramic substrate; whereby said three-dimensional colored photographic scenic image is set in ceramic on said ceramic substrate for providing a decorative ceramic colored photo object.

2. A method in accordance with claim 1 further comprising the step of applying a sealer coating to said dried and set ceramic paint colored photographic image.

3. A method in accordance with claim 2 wherein said ceramic paint applying step further comprises the step of applying a base primer coat to said ceramic substrate prior to applying said ceramic paint.

4. A method in accordance with claim 1 wherein said ceramic paint applying step further comprises the step of applying a base primer coat to said ceramic substrate prior to applying said ceramic paint.

5. A method in accordance with claim 1 wherein said ceramic paint is a water based paint.

6. A method in accordance with claim 5 wherein said firing step comprises the step of firing said ceramic substrate containing said applied ceramic paint colored image in a home type oven at a temperature of approximately 300 degrees Fahrenheit for a duration of about 30 minutes to dry and set said ceramic paint colored image on said ceramic substrate.

7. A method in accordance with claim 4 wherein said ceramic paint is an acrylic paint.

8. A method in accordance with claim 1 wherein said ceramic paint is an acrylic paint.

9. A method in accordance with claim 1 wherein said colored photographic scenic image comprises a portrait.

10. A method in accordance with claim 1 wherein said transferring step further comprises the step of creating a thermal transfer image of said colored photographic image from said digitized representation thereof and thermally applying said transfer image to said ceramic substrate for providing an image template; said ceramic paint applying step comprising the step of applying said ceramic paint to said applied thermally transferred image template for providing said reproduced colored photographic scenic image on said ceramic substrate in said ceramic paint.

11. A method in accordance with claim 10 wherein said colored photographic scenic image comprises a portrait.

12. A method in accordance with claim 1 further comprising the step of applying said ceramic paint color representations to said ceramic substrate through an ink jet printer adapted for spraying said ceramic paint onto said ceramic substrate for reproducing said colored photographic scenic image on said ceramic substrate in said ceramic paint, said transferring step comprising the step of controlling said ink jet printer in accordance with said digitized representation of said actual colored photographic image for applying said ceramic paint to said ceramic substrate in colors corresponding to said actual colored photo.

13. A method in accordance with claim 12 wherein said ceramic paint is a water based paint.

14. A method in accordance with claim 13 wherein said firing step comprises the step of firing said ceramic substrate containing said applied ceramic paint colored image in a home type oven at a temperature of approximately 300 degrees Fahrenheit for a duration of about 30 minutes to dry and set said ceramic paint colored image on said ceramic substrate.

15. A method in accordance with claim 12 wherein said ceramic paint is an acrylic paint.

16. A method in accordance with claim 12 wherein said colored photographic scenic image comprises a portrait.

17. A method for providing a three-dimensional photographic scene image on a ceramic substrate comprising the steps of providing an image template of an actual colored photographic image of a scene on said ceramic substrate; applying ceramic paint color representations of said actual colored photographic image to said image template for reproducing said colored photographic scenic image on said ceramic substrate in said ceramic paint; and firing said ceramic substrate containing said applied ceramic paint colored image at a predetermined temperature and duration sufficient to dry and set said ceramic paint colored image on said ceramic substrate; whereby said three-dimensional colored photographic scenic image is set in ceramic on said ceramic substrate for providing a decorative ceramic colored photo object.

18. A method in accordance with claim 17 wherein said colored photographic scenic image comprises a portrait.

19. A method in accordance with claim 1 wherein said ceramic substrate comprises a frame adjacent to said ceramic paint colored image.

20. A method in accordance with claim 1 further comprising the step of glazing said dried and set ceramic painted image on said ceramic substrate.
